(19) United States
(12) Patent Application Publication
(10) Pub. No.: US 2024/0134436 A1
(43) Pub. Date: Apr. 25, 2024

(54) SOFTWARE-DIRECTED SILICON POWER DELIVERY NETWORK

(71) Applicants: Akhilesh Thyagaturu, Tampa, FL (US); Karthik Kumar, Chandler, AZ (US); Francesc Guim Bernat, Barcelona (ES); Manish Dave, Folsom, CA (US); Xiangyang Zhuang, Lake Zurich, IL (US)

(72) Inventors: Akhilesh Thyagaturu, Tampa, FL (US); Karthik Kumar, Chandler, AZ (US); Francesc Guim Bernat, Barcelona (ES); Manish Dave, Folsom, CA (US); Xiangyang Zhuang, Lake Zurich, IL (US)

(21) Appl. No.: 18/401,241

(22) Filed: Dec. 29, 2023

(51) Int. Cl. G06F 1/26; H02J 3/00

(52) U.S. Cl. CPC G06F 1/26; H02J 3/00

(57) ABSTRACT

An integrated circuit (IC) device, such as a system on chip, includes a plurality of hardware circuitry components and a power delivery network to delivery power to the plurality of hardware circuitry elements. The power delivery network has a plurality of integrated switches and a corresponding data plane to couple the plurality of switches to a controller on the IC device. The controller sends signals on the control plane of the power delivery network to granularly select which of the plurality of hardware circuitry elements to power-gate and may do so at the direction of a software system.

### TECHNICAL FIELD

This disclosure relates in general to the field of computing, and more particularly, though not exclusively, to integrated controls in power delivery networks of integrated circuit devices.

### BACKGROUND

A datacenter may include one or more platforms each including at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications. Bit errors may arise on networks, links, and interconnect fabrics used to interconnect components in a datacenter. Error detection and error correction mechanisms have been developed to attempt to address such errors in modern computing systems.

Various integrated circuit devices may be provided on a computing platform, including system on chip (SoC) devices. An integrated circuit package typically includes an integrated circuit die and a substrate on which the die is mounted. The die can be coupled to the substrate through bonding wires or solder bumps. Signals from the integrated circuit die may then travel through the bonding wires or solder bumps to the substrate. As demands on integrated circuit technology continue to outstrip even the gains afforded by ever decreasing device dimensions, more and more applications demand a packaged solution with more integration than possible in one silicon die. In an effort to meet this need, more than one die may be placed within a single integrated circuit package (i.e., a multichip package). As different types of devices cater to different types of applications, more dies may be required in some systems to meet the requirements of high performance applications.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram illustrating components of a datacenter in accordance with certain embodiments.

FIG. 2 is a block diagram illustrating an example system on chip (SoC) device.

FIG. 3 is a block diagram illustrating an example power delivery network of an example integrated circuit (IC) device.

FIG. 4 is a block diagram illustrating an example integrated circuit (IC) device with a power delivery network with integrated switches.

FIG. 5 is a block diagram illustrating an example IC device with controller coupled to a software system.

FIG. 6 is a simplified block diagram illustrating example switches integrated with a power delivery network of an IC device.

FIG. 7 is a simplified block diagram illustrating example data for use in controlling a power delivery network of an IC device.

FIG. 8 is a simplified block diagram illustrating an example system including a software-based controller.

FIG. 9 is a simplified flow diagram illustrating multiple IC devices with power delivery networks controlled by a software-based controller.

FIG. 10 is a simplified flow diagram illustrating an example technique for controlling a power delivery network of an example IC device.

FIG. 11 is a block diagram illustrating an example processor device in accordance with certain embodiments.

### EMBODIMENTS OF THE DISCLOSURE

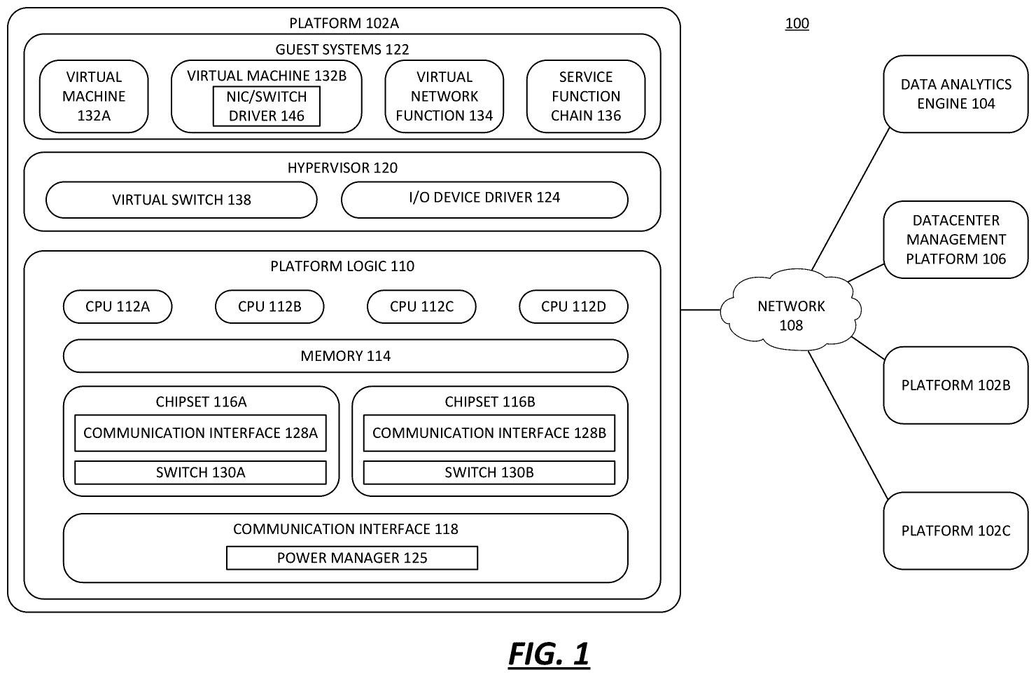

FIG. 1 illustrates a block diagram of components of a datacenter 100 in accordance with certain embodiments. In the embodiment depicted, datacenter 100 includes a plurality of platforms 102 (e.g., 102A, 102B, 102C, etc.), data analytics engine 104, and datacenter management platform 106 coupled together through network 108. A platform 102 may include platform logic 110 with one or more central processing units (CPUs) 112 (e.g., 112A, 112B, 112C, 112D), memories 114 (which may include any number of different modules), chipsets 116 (e.g., 116A, 116B), communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications.

Each platform 102 may include platform logic 110. Platform logic 110 includes, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that includes multiple platforms coupled together through network 108 (which may include, e.g., a rack or backplane switch).

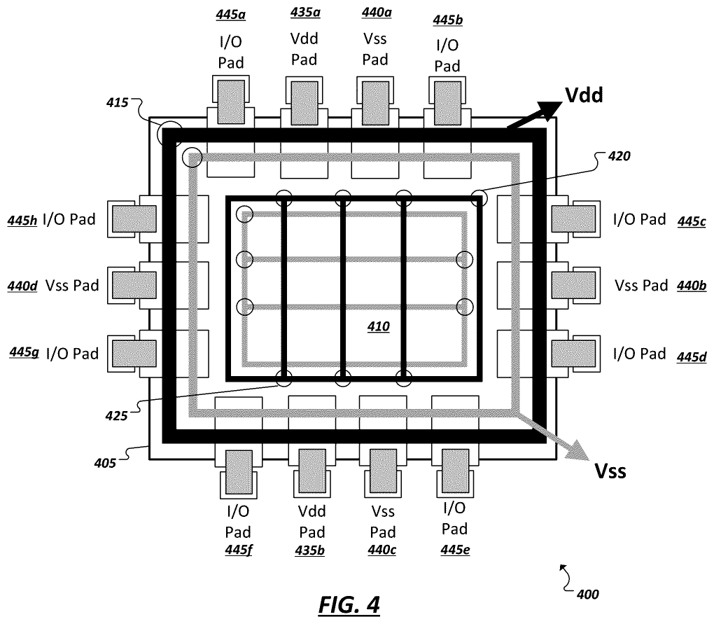

CPUs 112 may each include any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. CPU 112 is described in further detail below in connection with FIG. 4. Although four CPUs are shown, a platform 102 may include any suitable number of CPUs.

Memory 114 may include any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also include storage for instructions that may be executed by the cores of CPUs 112 or other processing elements (e.g., logic resident on chipsets 116) to provide functionality associated with components of platform logic 110. Additionally or alternatively, chipsets 116 may each include memory that may have any of the characteristics described herein with respect to memory 114. Memory 114 may also store the results and/or intermediate results of the various calculations and determinations performed by CPUs 112 or processing elements on chipsets 116. In various embodiments, memory 114 may include one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 including any suitable logic to support the operation of the CPUs 112. In some cases, chipsets 116 may be implementations of graph processing devices, such as discussed herein. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via one or more integrated I/O controllers resident on each CPU.

Chipsets 116 may each include one or more communication interfaces 128 (e.g., 128A, 128B). Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130 (e.g., 130A, 130B)) and another device coupled to network 108. In some embodiments, network 108 may include a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (i.e., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (i.e., software) switch.

Platform logic 110 may include an additional communication interface 118. Similar to communication interface 128, this additional communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 includes one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may include a processor core interrupt; a request to instantiate a software component, such as an I/O device driver 124 or virtual machine 132 (e.g., 132A, 132B); a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may include a single virtual machine (e.g., virtual machine 132A or 132B) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132B may be paravirtualized. For example, the virtual machine 132B may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may include a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is a group of VNFs 134 organized as a chain to perform a series of operations, such as network packet processing operations. Service function chaining 136 may provide the ability to define an ordered list of network services (e.g. firewalls, load balancers) that are stitched together in the network to create a service chain.

A hypervisor 120 (also known as a virtual machine monitor) may include logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may include a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may include a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may include any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can include any number of hardware or software elements coupled to (and in communication with) each other through a communications medium. In various embodiments, guest systems 122 may communicate with nodes that are external to the datacenter 100 through network 108.

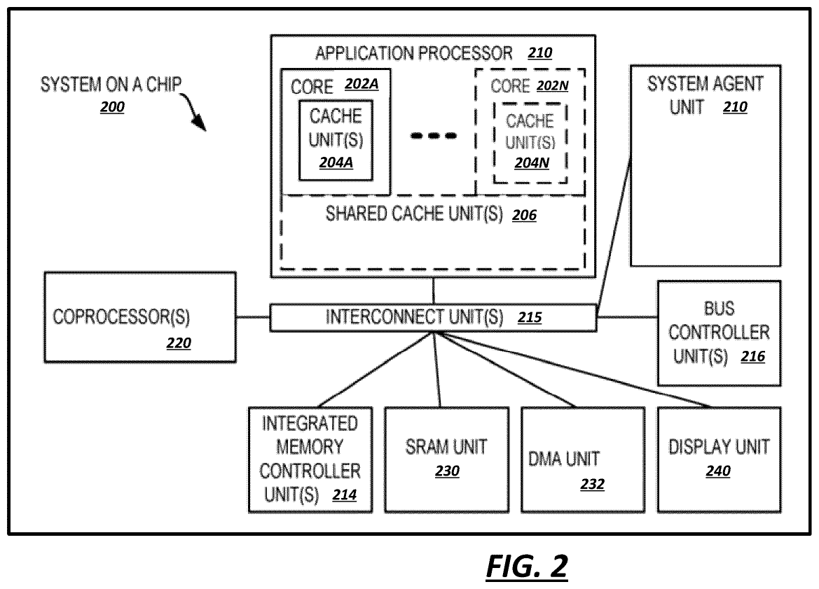

A computing platform, such as a datacenter, may incorporate a variety of integrated circuit devices, including CPUs, memory devices, chipsets, intellectual property blocks, and other devices. System on chip (SoC) devices may also be incorporated within a computing platform. An SoC may incorporate multiple components of a computing platform onto a single silicon die or chip, including processors (e.g., CPU, GPU, ASIC, etc.), memory (e.g., RAM), storage, I/O components, power management, and so on. FIG. 2 is a block diagram of an example SoC 200 In FIG. 2, an interconnect unit(s) 215 is coupled to: an application processor 210 which includes a set of one or more cores 202A-N and shared cache unit(s) 206; a system agent unit 210; a bus controller unit(s) 216; an integrated memory controller unit(s) 214; a set or one or more coprocessors 220 which may include integrated graphics logic, an image processor, an audio processor, and a video processor; an static random access memory (SRAM) unit 230; a direct memory access (DMA) unit 232; and a display unit 240 for coupling to one or more external displays. In one embodiment, the coprocessor(s) 220 include a special-purpose processor, such as, for example, a network or communication processor, compression engine, GPGPU, a high-throughput MIC processor, embedded processor, or the like.

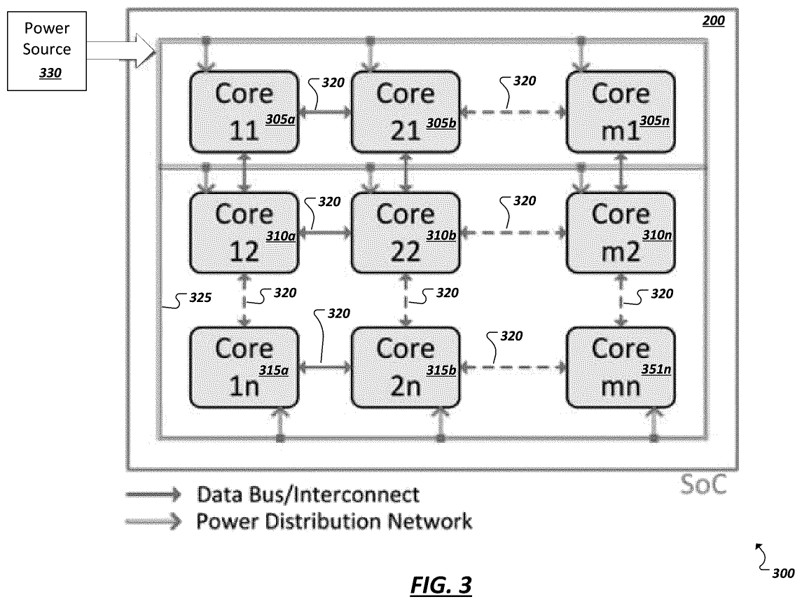

Complex IC devices, such as SoCs, may additionally complicate power management of the device. For instance, distribution of power to the various components or circuits within the IC device may be complicated by consideration of voltage leaks, signal degradation, thermal management, and other considerations. Certain requirements or policies may be associated with a given IC device, including its power usage, thermal thresholds, signal quality, among other issues. Turning to FIG. 3, a simplified block diagram 300 is shown of an example SoC device 200, with multiple components (e.g., 305a-n, 310a-n, 315a-n, etc.) interconnected on the SoC by a fabric or interconnect 320 of data buses coupling the components to allow communication and interoperation between the components. While FIG. 3 shows the components as “cored” it should be appreciated that an SoC may include a variety of different components and circuits in addition to processing cores and that the interconnect(s) integrated on the silicon of the SoC may also interconnect these elements. For instance, components and circuits of the SoC may include a group of transistor and interconnect structures that implement a single Boolean or other logic function (e.g., AND gate, OR gate, XOR gate, XNOR gate, inverter, etc.) or a storage function (e.g., flipflop or latch), as well as groupings of such structures representing less than all of a high-level function (e.g., of execution of an IP block on the SoC). Additionally, a power distribution network 325 may be provided on the device 200 to distribute power from one or more power sources 330 to the various components (e.g., 305a-n, 310a-n, 315a-n, etc.) of the SoC. In some implementations, the power distribution network 325 may be a grid-based power distribution network integrated within the silicon, although a variety of different power distribution topologies may be adopted within embodiments discussed herein.

In traditional systems, when an SoC (or other IC device) is turned on and used to execute a particular application or other workload, there may be significant portions and elements (e.g., IP blocks, logic circuitry (e.g., logic gates), cores, standard cells (e.g., flip-flops), etc.) of the SoC, which receive power (with Vdd and Vss sources), but do no work within the application. In other words, such powered-on circuitry is “unused.” If the unused circuitry is also unable to be dynamically power-gated (e.g., via power gating provided on the corresponding IP block or core), the elements may be referred to as “dark silicon.” Indeed, dynamically and precisely power-gating elements on a complex IC can be quite difficult. For instance, complex circuitry may be utilized and integrated on the die to implement the power delivery network needed for the complex array of circuits implementing a chipset (e.g., an SoC or other chipset, such as discussed in the example systems of FIGS. 1 and 2). Moreover, identifying which gates or circuitry are unused may be at least as difficult to determine with precision, making the determination of what to power-gate on the SoC quite complicated. Accordingly, solutions have not been developed to power-gate dark silicon space in modern SoC at high resolution, given these challenges.

Some IP blocks within an SoC may include component-driven power-gating logic, such as dynamic voltage and frequency scaling (DVFS), but such solutions are often limited to providing only very high-level (e.g., low resolution) control of only the corresponding IP block (e.g., and not subsections of the IP block, much less at the direction of external logic or at the standard cell level) and are limited to controlling power for only a potentially very narrow subset of the overall components on a die (e.g., the few components that natively include such functionality). Accordingly, while one SoC device (e.g., a specialized microcontroller with DVFS) may be capable of being controlled, large portions of dark silicon may remain in spite of these provisions, among other example issues.

In an improved system, a power delivery network may be implemented on a die and outfitted with granular control plane or control signaling network (also referred to herein at a “control network”), integrated with the power delivery network to allow high-resolution power gating (e.g., down to the gate or standard-cell level) on the chip, as well as software-defined control of the power gating, among other example features. For instance, FIG. 4 is a simplified block diagram 400 illustrating an example die of a computing device 405 including a power delivery network (PDN) 410 (e.g., a grid-based PDN) that include power delivery lines (e.g., rings, strips, rails, etc.) outfitted with a collection of switches (e.g., 415, 420, 425, etc.) in the lines that can be controlled granularly using controller circuitry on the device. The die may include conductors to implement pads or other interfaces to implement Vdd (positive voltage supply) ports 435a-b, Vss (negative voltage supply or ground) ports 440a-d, as well as non-power interfaces (e.g., I/O ports 445a-h). The various lines provided for in the PDN 410 may delivery power to certain individual elements (e.g., circuit blocks, cores, etc.), as well as to certain sectors or regions of the die to power corresponding standard-cells, gates, or groups of gates within the region. The granularity of the power-gating of the PDN can be adjusted based on how many switches on provided in the network (e.g., switches corresponding to respective regions or IP blocks versus gates corresponding to individual standard-cells or logic gates). When a switch is turned off, one or more elements attached to a line associated with the switch may be cut off from Vdd 450 and Vss 455 (e.g., to avoid leakage current in the SoC). Accordingly, portions of the SoC circuitry that are predicted, expected, or known to be “dark” during a particular workload, may be selectively turned off with precision using a corresponding subset of integrated switches (e.g., 415, 420, 425) on the PDN 410.

Software may interface with an on-die controller circuitry block of SoC 405 that is communicatively coupled to the various switches (e.g., 415, 420, 425) integrated on the lines of the PDN. Accordingly, software may dictate (e.g., on an application or workflow level), what circuitry of a chip the software will used to perform its workload and utilize the controller and PDN switches to power-gate those portions of the chip's circuitry that the application will not use. As such, a switch-based PDN 410 may be provided, which can be dynamically configured using software at the gate, cell, logic, or IP block level (e.g., based on the switch granularity provided on the PDN). Accordingly, power delivery on the chip (e.g., SoC) can be dynamically adapted to match the precise requirements or policies defined for a given system or application, reducing instances of dark silicon and the associated wasted energy) and significantly enhancing power efficiency, as well as control over voltage leakage and the thermal profile of the overall SoC, among other example advantages and features.

A solution enabling high-resolution, even gate- or standard-cell-level, power-gating, such as introduced in the example of FIG. 4, may be particularly beneficial in some architectures. As an example, complex instruction set computer (CISC) architectures implementations struggle to achieve power saving comparable to corresponding reduced instruction set computer (RISC) architectures. In theory, a CISC-based system translates to a higher gate density SoC, while a RISC-based system translates to a lower gate density SoC. If true, higher-resolution power control (e.g., at the gate level) could be utilized to allow a CISC-based SoC to have power characteristics similar to a comparable RISC-based SoC, among other examples.

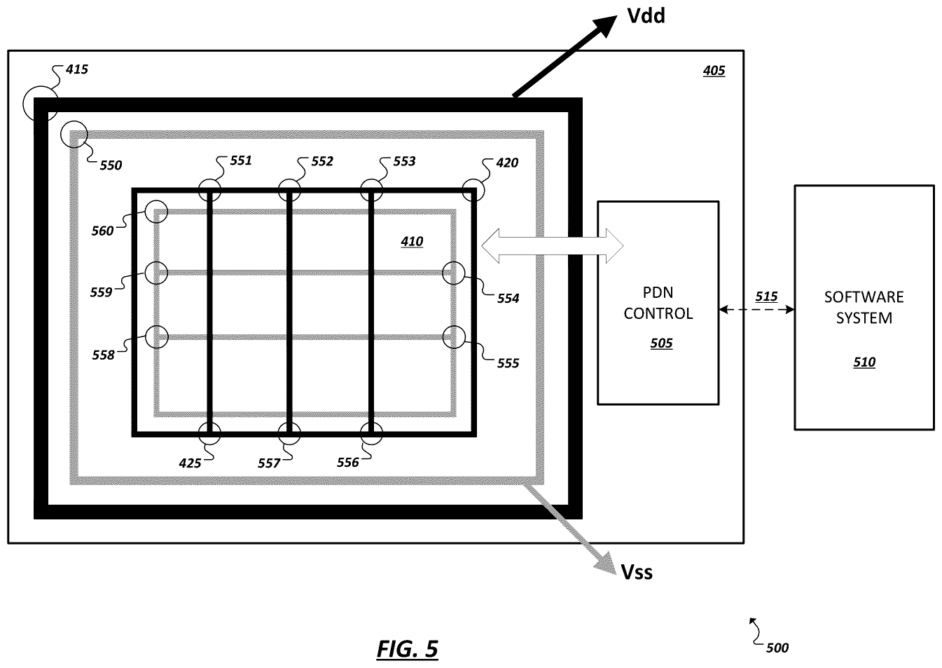

Turning to FIG. 5, a simplified block diagram 500 is shown illustrating an example SoC device 405 including a PDN 410 with integrated switches (e.g., 415, 420, 425, 550-560, etc.) and controller hardware 505 coupled to a software system 510 via an interface 515 with the controller hardware 505. In some implementations, it may be advantageous to plan and forecast power usage patterns of a particular SoC during design phase, both in the design of the topology of the power delivery network (e.g., how many topological layers or branches are in the network) and the number and placement of the controllable integrated switches within the PDN. For instance, a PSN-switch topology may be selected and implemented to allow multiple areas or elements of the SoC to be simultaneously switched off using a single switch for an entire branch of the network (in addition to being able to switch off individual sub-branches or leaves of the PDN). The topology may anticipate the need for more granular control in some regions of the silicon (e.g., around various individual or groupings of gates or standard cells) and less granular control in others (e.g., for a connection to an IP block with integrated power-gating logic, among other examples. Various rings, strips, and rails of the PDN may incorporate the controllable switch elements to allow the enabling and disabling of power delivery to be controller down to the gate or standard-cell level.

Each of the integrated switches may be coupled via a control network to one or more controller circuits, allowing the controller hardware 505 to send signals to the switches and enable/disable power delivery to corresponding elements coupled to that line. Control lines and signaling within the control plan may be multiplexed and combined, in some implementations, to develop and enable high level functions and signals, to allow a combination of standard-cells and other elements to enabled/disabled with a single signal sent by the controller hardware 505, among other examples. The control signals may be independent and separate from other I/O interconnections between devices on the SoC 405. Software-based logic 510 (e.g., associated with an application, an operating system, hypervisor, orchestrator, or other utility) may send signals (e.g., via an API and/or driver) to the controller hardware 505 to cause corresponding control signals to be sent on the control network of the PDN and enable/disable various elements of the SoC (or even restore the SoC (e.g., by enabling any disabled elements) to a default state). The software system 510 may thereby dynamically adjust and manage the power state of fundamental components of the SoC as low as individual logic gates.

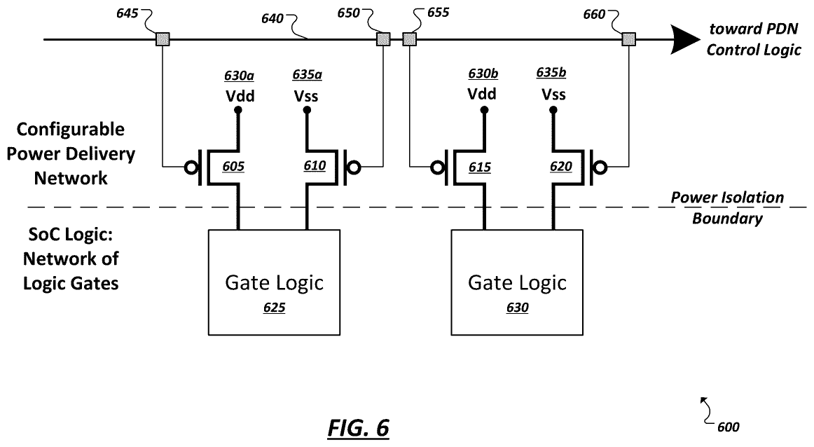

FIG. 6 is a simplified circuit diagram 600 illustrating examples of switch circuits (e.g., 605, 610, 615, 620) integrated within a PDN of an IC device to control power delivery to individual elements (e.g. 625, 630) of the device, such as individual standard-cells, flip-flops, logic gates, etc. In this example, each of the switch circuitry may be coupled to a Vdd (e.g., 630a,b) and Vss line (e.g., 635a,b) in the PDN, and may be further coupled to a control network bus 640 of the PDN. Various aggregation points (e.g., 645, 650, 655, 660) may be provided on the control network bus 640 and equipped with hardware logic to identify a signal sent on the control network bus 640 and determine that a signal arriving at the aggregation point (e.g., 645) is associated with a given switch or grouping of switches (e.g., 605), with the aggregation point allowing a binary value (e.g., high or low) control signal to be sent to the switch (e.g., 605) causing the switch to flip on/off and thereby enable or disable the power (e.g., provided through Vdd 630a) to an associated element (e.g., 625). In some implementations, aggregation points, switches, or other circuitry may be provided to not only cause individual switches to be engaged/disengaged, but to also detect when the underlying silicon space (e.g., gates, cells, or logic) they are driving is being used or un-used for a given workload. For instance, sensor circuitry may be provided to monitor voltage and/or current at a branch of the PDN, a switch, or other PDN element. In some implementations, sensory circuitry may be present to monitor the status of gate logic, among other state information. Information derived by these sensors may be carried over a control network provided in association with the PDN to allow usage information to be derived for various sub-element (even standard cell-level circuits) of an SoC. Accordingly, the PDN circuitry may also be used as the basis for determining application- or system-specific use mapping information to the SD-PDN control signaling network, among other example features.

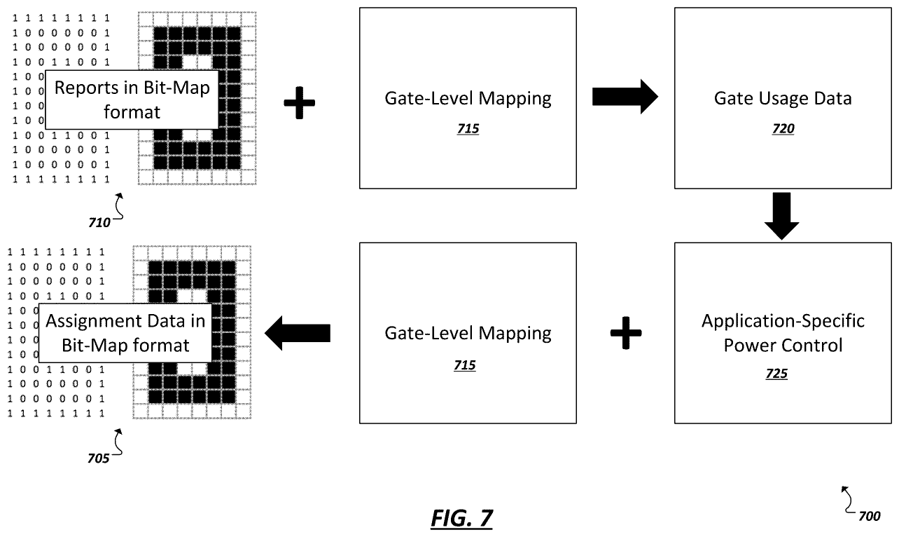

FIG. 7 is a simplified block diagram 700 illustrating example signals and data to control the power gating to specified subsets of cells, gates, or other elements of an example SoC device. In this example, a bit-map or bit-mask 705 may be received at controller hardware associated with the SoC PDN (e.g., from or generated based on an instruction received from a software system controller). The bit-map may identify, for each integrated switch in a PDN (or identified subsection of the PDN), which switches to close to provide power to corresponding circuit elements (e.g., designated by a “1” for the switch location in the bit map) and which switches to open to power-gate corresponding elements (e.g., as designated by a “0” in the bit-map).

In some implementations, a software-based controller may be utilized to process data describing what hardware elements (e.g., logical gates, standard-cells, etc.) are expected to be unused in a given workflow (e.g., corresponding to execution units, memory, etc. that will not be used to perform a set of tasks in the workflow) and generate the switch engagement data (e.g., 705) based on this information. In the example of FIG. 7, report data 710 may be assembled throughout monitoring of the SoC to determine (e.g., on a PDN switch basis), which hardware elements of the SoC have been used in past performance of similar tasks and workloads. Mapping data 715 may be maintained to map which PDN switches correspond to not only which specific granular hardware element, but also to the macro-level components and logic implemented by these specific components (e.g., a network interface controller, a memory block, a specific execution unit of a processor, etc.). This mapping (e.g., 715) may be used, for instance, in combination with report data 710 to determine gate usage data 720 describing, on a hardware element basis, usage metrics of various hardware elements for various tasks. This usage data 720 may be later used (e.g., by the software system controller) to generate an application-, workload-, or task-specific power control plan data 725 for the application, workload, or task that incorporates knowledge gleaned from the report data 710 in generating switch engagement data 705 for the specific workload, which may be fed to the PDN hardware controller to cause a select subset of hardware elements of the SoC to be power-gated for the workload.

In some implementations, a machine learning model or artificial intelligence algorithm may be applied (e.g., by the software system) to generate the power control plan data for a particular workload (e.g., based on a machine-learning model trained on a collection of report data and application data) to predict (e.g., for a given workload to be executed on the SoC) what gates may be safely powered-off during the execution of the workload, among other examples. In the sense that switch engagement data 705 may be applied on an application- or workload-basis, control of the switches of the PDN for the workload may operate at a macro-level in the time domain (e.g., measured in seconds). Such macro-level control does not compromise micro-level performance (e.g., of the underlying hardware elements, which operates at much smaller timescales (e.g., nanoseconds and microseconds)). Indeed, dynamic and high-resolution control of power-gating within the SoC allows for unprecedented control over power delivery within the SoC, achieving high level of granularity, and offering both macro-level and micro-level power management without sacrificing performance.

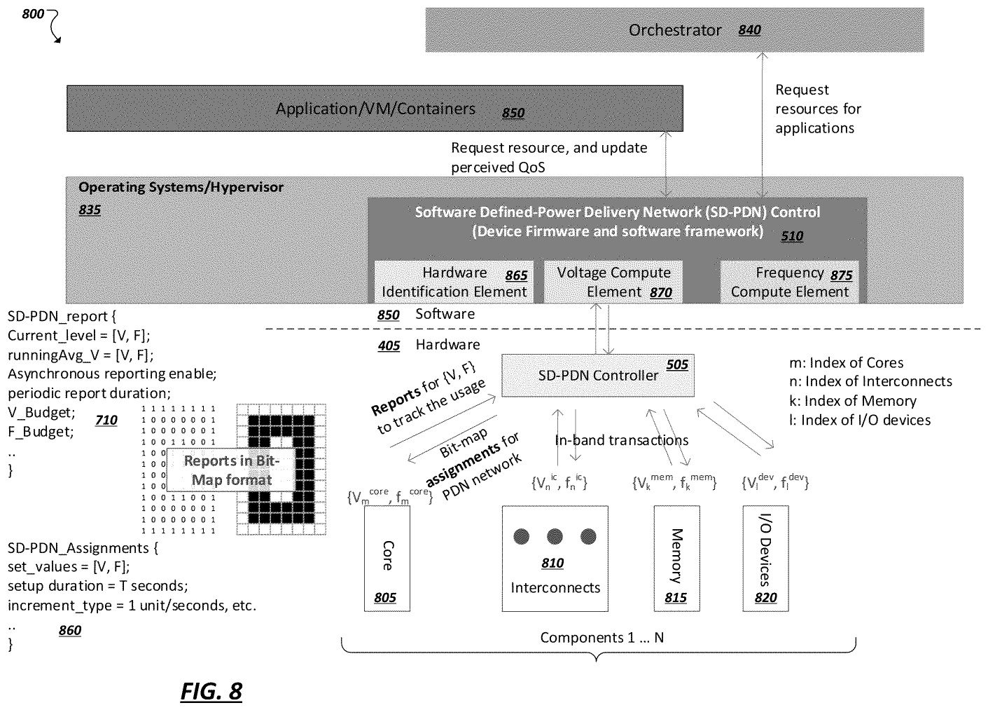

FIG. 8 is a simplified block diagram 800 of an example system including a hardware device 405 (e.g., SoC) with a collection of various components (e.g., 805, 810, 815, 820, etc.). Individual components may be implemented using composite circuit elements (e.g., standard-cells, logic circuits, etc.) and switches integrated within the PDN of the device 405 may be implemented to allow only subsections (e.g., one or a collection of logic gates) of larger component (e.g., a core, protocol circuitry, memory, I/O components, etc.) to be power-gated using the PDN and associated hardware controller 505. Report data (e.g., 710) can also be generated to identify usage metrics (e.g., power usage, including voltage and frequency information) associated with each of the PDN switches and associated segments of the device 405. Such report data may be provided, for instance, asynchronously, in response to on-demand requests, as signals that are pushed out to monitoring circuitry (e.g., at a given frequency), for instance, by reading a corresponding control bus for values, among other examples.

In some implementations, a hardware device 405 may be incorporated within a server, data center platform, or other platform used to execute various software applications 850. In the example of FIG. 8, software layers 830 may include the operating system or hypervisor (e.g., 835), as well as an orchestrator 840 for use in identifying and provisioning computing resources (e.g., within a cloud, edge, or other distributed computing environment), such as the resources (e.g., 805, 810, 815, 820, etc.) provided through hardware device 405. In this example, orchestrator 840 may instantiate an operating system (and/or hypervisor) 835 on the hardware device, with the application (and/or virtual machine and/or container) 850 to be run on the operating system 835. The application 850 may have a set of parameters (e.g., quality of service (QoS) requirements) defined for the application, including power requirements, among other examples. A software-defined PDN (SD-PDN) controller (e.g., 510) may be provided on the operating system 835 to interface with and send control signals to the controller hardware 505 on the hardware device 405. The control signals generated by the SD-PDN controller may be based on the QoS policies set for the application (e.g., power usage parameters, etc.). The controller hardware 505, in turn, may generate corresponding signals to cause a subset of switches integrated on the PDN to be flipped to power-gate associated elements of the hardware device.

In one example, the SD-PDN controller 510 may include data describing gate-level mappings within the hardware device, such that the SD-PDN controller 510 has an understanding of which PDN switches map to which functionality and resources provided by the hardware device 405. The SD-PDN controller 510, in some implementations, may analyze report data 710, together with information regarding the application 850 (e.g., obtained from the application 850, the orchestrator 840, etc.) to determine the control signal (e.g., 860) to send to the controller hardware 505 for use in generating the PDN control network bus signaling to precisely power-gate unnecessary hardware elements of the hardware device 405 (e.g., to assist in complying with a power-related policy for the application), among other examples. In one example, the SD-PDN controller 510 may include a voltage compute element 870 to evaluate bit-map data (e.g., 710) and control the enabling and disabling of voltage, or even control the voltage level to apply to respective portions of the PDN. A frequency compute element 875 may be provided to implement the operating clock control for each component controlled by the SD-PDN controller 510, among other examples.

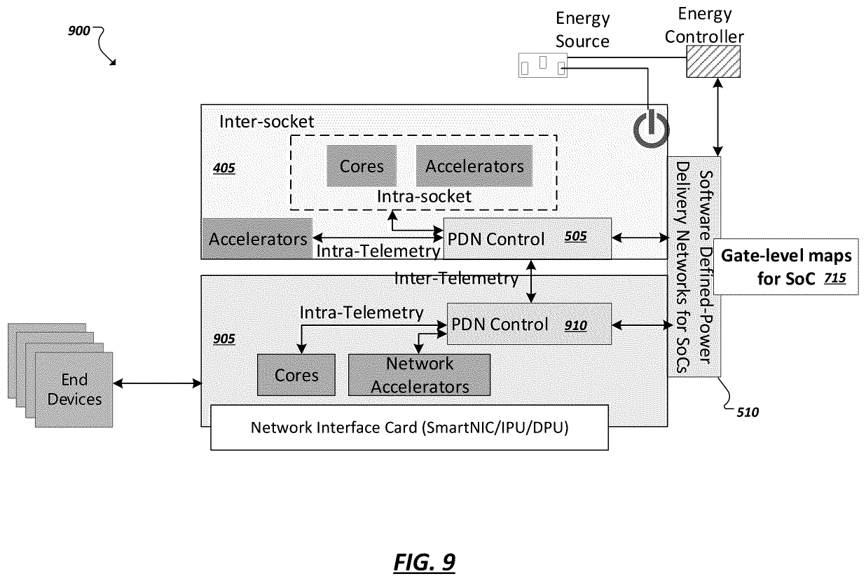

In some implementations, modern applications and workloads may utilize multiple devices (e.g., on a server, in a data center, within an edge computing system, etc.) in concert to execute the application end-to-end. In some implementations, multiple devices for use in performing a particular workload may each include respective PDNs with integrated switches enabling fine, granular power-gating of hardware elements of each device. FIG. 9 is a simplified block diagram 900, showing an example of multiple devices (e.g., 405, 905) included within a system and utilized together to implement a particular end-to-end application. For instance, a first one of the devices (e.g., 405) may include first hardware and functionality and a second one of the devices may include other additional hardware and functionality not possessed by the first device, but that is to be used in order to implement the particular application. In other examples, the first and second devices may be substantial similar devices (e.g., with comparable hardware and functionality), but which may be used in concert in an end-to-end application to effectively double the available resources and improve the overall performance of the application, among other example implementations.

Continuing with the example of FIG. 9, both of the first 405 and second devices 905 may include respective PDNs with integrated controllable switches and may likewise include respective controller hardware blocks 505, 910 associated with the PDN to send signals on a control network of the respective PDN and granularly control which switches will be flipped to power-gate corresponding associated hardware portions of the respective device. In one example, a single SD-PDN controller 510 of the platform to which the first and second devices are associated may interface with both of the controller hardware blocks and determine end-to-end power control across the multiple device 405, 905. Likewise, in some implementations, report data generated through the respective PDN controls of each device 405, 905 may be shared with the SD-PDN controller 510 to allow the SD-PDN controller 510 to have access to granular telemetry across both hardware devices 405, 905. Additionally, the SD-PDN controller 510 may have access to or develop gate-level mapping data (e.g., 715) for not only a single one of the devices (e.g., 405) but a collection of multiple devices (e.g., 405, 905), such as multiple SoC devices or other ICs connected by die-to-die or package-to-package links, among other examples.

In one example, the SD-PDN controller 510 may include logic to implement an energy-aware platform (including the multiple devices) and may use end-to-end telemetry information to decompose tasks within a workload and coordinate power control across the multiple devices (e.g., 405, 905) at various advantageous control points. Such comprehensive and granular control may allow end-to-end key performance indicators (KPIs) and/or QoS metrics to be considered and addressed using the SD-PDN controller 510, by allowing respective portions of each of the multiple hardware devices in the system to be granularly power-gated (e.g., based on thermal capacity objectives or thresholds) and may adjust the power-gating based on the evolving or projected chain of workload demand across the multiple devices, among other examples.

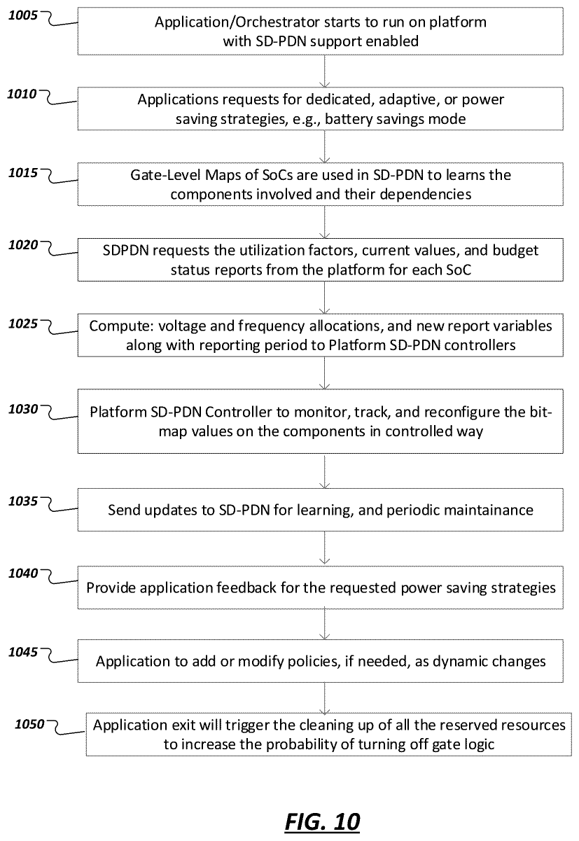

FIG. 10 is a flow diagram 1000 illustrating example techniques for controlling power-gating on an IC device (e.g., an SoC), which includes a PDN with integrated switches controllable by a software system. For instance, an application, orchestrator, or other software program may begin running on a computing platform that includes the IC device. The application may support software-defined PDN power-gating. The application may have associated policies, KPIs, QoS standards, or other settings relating to power utilization, and may request 1010 (to a software controller) that dedicated, adaptive, or other power saving strategies be employed during its execution. The software-based controller may access 1015 mapping data to identify which integrated PDN switches map to which components of the IC device and associated functionality to identify the components that are to be involved in the execution of the application and any dependencies between the components.

In one example, to determine instructions to be sent to the PDN hardware controller of the IC Device, the software controller may request 1020 additional details from a utility of the IC device or the platform on which the IC device is mounted (e.g., the PDN hardware controller or another resource), such as utilization factors, current values, budget status reports, among other example information. The software controller may calculate 1025 additional information such as voltage and frequency allocation for various elements of the IC device (e.g., new report variables of component specific features (e.g., voltage, operating frequency, current, power, etc.) over various reporting periods (e.g., periodic or on-demand reads, etc.). Based on this information (e.g., collected and determined by the software controller, the software controller may determine 1030 a configuration for the switches of the IC device's PDN to selectively power-gate select sections of the IC device (e.g., that are expected to remain unused or “dark” during all or a subset of tasks of the application). The software controller may monitor performance of the application (utilizing the IC device) and may dynamically adjust the power-gating configuration, for instance, by sending 1035 one or more update signals to the IC device to cause a different subset of switches to be engaged to power-gate a different subset of hardware elements of the IC device. In some cases, the software controller may send updates (and cause sections of an IC device to be power-gated) to assess the effect of such power-gating (e.g., on performance), to perform maintenance tasks, testing, or other example uses.

Continuing with the example of FIG. 10, a software controller, in addition to directing the IC hardware and PDN to perform specific power gating using integrated PDN switches, may communicate with the application or other program associated with the workload to provide feedback data 1040, which may describe the actions taken, performance characteristics, power savings results, and other observations made by the software controller (e.g., based on its interface with the PDN controller hardware controller of the IC device). In some instances, the application may use such information in connection with its execution, such as adding or modifying (e.g., 1045) policies dynamically during execution, among other examples. When execution of the application or workload is completed, the application exit 1050 may cause the results of the selective hardware power-gating on the application's execution to be recorded (e.g., to be considered for use in driving future power-gating instructions) and other learning by the software controller. In some implementations, the software controller may send additional switch engagement data to the IC device in concert with the completion of the workload to reset or otherwise prepare the IC device hardware for its next workload(s), among other examples.

Note that the apparatus', methods', and systems described above may be implemented in any electronic device or system as aforementioned. As a specific illustration, FIG. 8 provides an exemplary implementation of a processing device such as one that may be included in a network processing device. It should be appreciated that other processor architectures may be provided to implement the functionality and processing of requests by an example network processing device, including the implementation of the example network processing device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

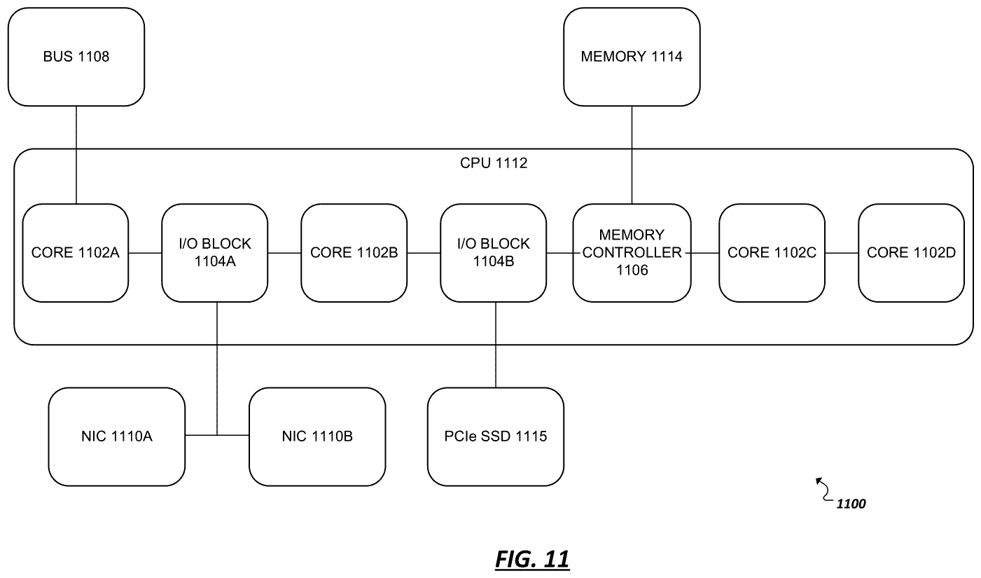

Referring to FIG. 11, a block diagram 1100 is shown of an example data processor device (e.g., a central processing unit (CPU)) 1112 coupled to various other components of a platform in accordance with certain embodiments. Although CPU 1112 depicts a particular configuration, the cores and other components of CPU 1112 may be arranged in any suitable manner. CPU 1112 may comprise any processor or processing device, such as a microprocessor, an embedded processor, a digital signal processor (DSP), a network processor, an application processor, a co-processor, a system on a chip (SOC), or other device to execute code. CPU 1112, in the depicted embodiment, includes four processing elements (cores 1102 in the depicted embodiment), which may include asymmetric processing elements or symmetric processing elements. However, CPU 1112 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1112, as illustrated in FIG. 11, includes four cores—cores 1102A, 1102B, 1102C, and 1102D, though a CPU may include any suitable number of cores. Here, cores 1102 may be considered symmetric cores. In another embodiment, cores may include one or more out-of-order processor cores or one or more in-order processor cores. However, cores 1102 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1102 may include a decode module coupled to a fetch unit to decode fetched elements. Fetch logic, in one embodiment, includes individual sequencers associated with thread slots of cores 1102. Usually a core 1102 is associated with a first ISA, which defines/specifies instructions executable on core 1102. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. Decoders may, in some implementations, include logic designed or adapted to recognize specific instructions, such as transactional instructions. As a result of the recognition by the decoders, the architecture of core 1102 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1102, in one embodiment, recognize the same ISA (or a subset thereof). Alternatively, in a heterogeneous core environment, a decoder of one or more cores (e.g., core 1102B) may recognize a second ISA (either a subset of the first ISA or a distinct ISA).

In various embodiments, cores 1102 may also include one or more arithmetic logic units (ALUs), floating point units (FPUs), caches, instruction pipelines, interrupt handling hardware, registers, or other suitable hardware to facilitate the operations of the cores 1102.

Bus 1108 may represent any suitable interconnect coupled to CPU 1112. In one example, bus 1108 may couple CPU 1112 to another CPU of platform logic (e.g., via UPI). I/O blocks 1104 represents interfacing logic to couple I/O devices 1110 and 1115 to cores of CPU 1112. In various embodiments, an I/O block 1104 may include an I/O controller that is integrated onto the same package as cores 1102 or may simply include interfacing logic to couple to an I/O controller that is located off-chip. As one example, I/O blocks 1104 may include PCIe interfacing logic. Similarly, memory controller 1106 represents interfacing logic to couple memory 1114 to cores of CPU 1112. In various embodiments, memory controller 1106 is integrated onto the same package as cores 1102. In alternative embodiments, a memory controller could be located off chip.

As various examples, in the embodiment depicted, core 1102A may have a relatively high bandwidth and lower latency to devices coupled to bus 1108 (e.g., other CPUs 1112) and to NICs 1110, but a relatively low bandwidth and higher latency to memory 1114 or core 1102D. Core 1102B may have relatively high bandwidths and low latency to both NICs 1110 and PCIe solid state drive (SSD) 1115 and moderate bandwidths and latencies to devices coupled to bus 1108 and core 1102D. Core 1102C would have relatively high bandwidths and low latencies to memory 1114 and core 1102D. Finally, core 1102D would have a relatively high bandwidth and low latency to core 1102C, but relatively low bandwidths and high latencies to NICs 1110, core 1102A, and devices coupled to bus 1108.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: an integrated circuit (IC) device including: a plurality of hardware circuitry components; a power delivery network to deliver power to the plurality of hardware circuitry components; a plurality of switches coupled to the power delivery network to control whether power is delivered to respective portions of the plurality of hardware circuitry components; a control network for the power delivery network, where the control network is coupled to the plurality of switches; and controller circuitry to send a signal on the control network to cause power delivery to be disabled to a particular portion of the plurality of hardware circuitry components.

Example 2 includes the subject matter of example 1, where the plurality of switches are mapped to respective hardware circuitry components in the plurality of hardware circuitry components.

Example 3 includes the subject matter of example 2, where a particular one of the plurality of switches is mapped to and controls power delivery to a single standard cell in the plurality of hardware circuitry components.

Example 4 includes the subject matter of any one of examples 2-3, where a particular one of the plurality of switches is mapped to and controls power delivery to a single logic gate in the plurality of hardware circuitry components.

Example 5 includes the subject matter of any one of examples 1-4, where the integrated circuit device includes an intellectual property (IP) block, and the particular portion includes a subset of hardware of the IP block.

Example 6 includes the subject matter of any one of examples 1-5, where the integrated circuit device includes a system on chip.

Example 7 includes the subject matter of any one of examples 1-6, where the controller circuitry is to receive switch engagement data from software and generates the signal based on the switch engagement data.

Example 8 includes the subject matter of example 7, where the switch engagement data identifies, for each of the plurality of switches, whether the switch is to be open or closed.

Example 9 includes the subject matter of any one of examples 1-8, where the power delivery network is integrated in silicon of the integrated circuit device.

Example 10 includes the subject matter of any one of examples 1-9, where the controller circuitry is further to generate report data to indicate use of individual hardware circuitry components in the plurality of hardware circuitry components during a performance of a workload.

Example 11 is a non-transitory machine-readable storage medium with instructions stored thereon, the instructions executable to cause a machine to: identify an integrated circuit device to perform a workload, where the integrated circuit device includes a power delivery network to deliver power to a plurality of hardware circuitry components, the power delivery network includes a plurality of switches integrated in the power delivery network to control whether power is delivered to respective hardware circuitry components in the plurality of hardware circuitry components; send a signal to the integrated circuit device based on the workload to cause a subset of the plurality of switches to be triggered to disable power delivery to a corresponding subset of the plurality of hardware circuitry components; and trigger execution of at least a portion of the workload on the integrated circuit device while power delivery is disabled to the subset of the plurality of hardware circuitry components.

Example 12 includes the subject matter of example 11, where the subset of the plurality of hardware circuitry components includes at least one of an individual standard cell of the integrated circuit device or an individual logic gates of the integrated circuit device.

Example 13 includes the subject matter of any one of examples 11-12, where the instructions are further executable to cause the machine to determine that the subset of the plurality of hardware circuitry components will be unused in the execution of at least the portion of the workload, where the signal is generated based on the determination that the subset of the plurality of hardware circuitry components will be unused.

Example 14 includes the subject matter of example 13, where the instructions are further executable to cause the machine to receive report data from the integrated circuit device, where the subset of the plurality of hardware circuitry components are determined to be unused in the execution of at least the portion of the workload based on the report data.

Example 15 includes the subject matter of any one of examples 11-14, where the instructions are further executable to cause the machine to: identify policy data associated with the workload; and determine a power savings policy to be applied to the workload, where the signal is sent based at least in part on the power savings policy.

Example 16 includes the subject matter of any one of examples 11-15, where the plurality of switches are mapped to respective hardware circuitry components in the plurality of hardware circuitry components.

Example 17 includes the subject matter of any one of examples 11-16, where the integrated circuit device includes an intellectual property (IP) block, and the particular portion includes a subset of hardware of the IP block.

Example 18 includes the subject matter of any one of examples 11-17, where the integrated circuit device includes a system on chip.

Example 19 includes the subject matter of any one of examples 11-18, where the signal identifies, for each of the plurality of switches, whether the switch is to be open or closed.

Example 20 includes the subject matter of any one of examples 11-19, where the power delivery network is integrated in silicon of the integrated circuit device.

Example 21 is a method including: identifying an integrated circuit device to perform a workload, where the integrated circuit device includes a power delivery network to deliver power to a plurality of hardware circuitry components, the power delivery network includes a plurality of switches integrated in the power delivery network to control whether power is delivered to respective hardware circuitry components in the plurality of hardware circuitry components; sending a signal to the integrated circuit device based on the workload to cause a subset of the plurality of switches to be triggered to disable power delivery to a corresponding subset of the plurality of hardware circuitry components; and triggering execution of at least a portion of the workload on the integrated circuit device while power delivery is disabled to the subset of the plurality of hardware circuitry components.

Example 22 includes the subject matter of example 21, where the subset of the plurality of hardware circuitry components includes at least one of an individual standard cell of the integrated circuit device or an individual logic gates of the integrated circuit device.

Example 23 includes the subject matter of any one of examples 21-22, further including determining that the subset of the plurality of hardware circuitry components will be unused in the execution of at least the portion of the workload, where the signal is generated based on the determination that the subset of the plurality of hardware circuitry components will be unused.

Example 24 includes the subject matter of example 23, further including receiving report data from the integrated circuit device, where the subset of the plurality of hardware circuitry components are determined to be unused in the execution of at least the portion of the workload based on the report data.

Example 25 includes the subject matter of any one of examples 21-24, further including: identifying policy data associated with the workload; and determining a power savings policy to be applied to the workload, where the signal is sent based at least in part on the power savings policy.

Example 26 includes the subject matter of any one of examples 21-25, where the plurality of switches are mapped to respective hardware circuitry components in the plurality of hardware circuitry components.

Example 27 includes the subject matter of any one of examples 21-26, where the integrated circuit device includes an intellectual property (IP) block, and the particular portion includes a subset of hardware of the IP block.

Example 28 includes the subject matter of any one of examples 21-27, where the integrated circuit device includes a system on chip.

Example 29 includes the subject matter of any one of examples 21-28, where the signal identifies, for each of the plurality of switches, whether the switch is to be open or closed.

Example 30 includes the subject matter of any one of examples 21-29, where the power delivery network is integrated in silicon of the integrated circuit device.

Example 31 is a system including means to perform the method of any one of examples 21-30.

Example 32 is a system including: a first integrated circuit device: a plurality of hardware circuitry components; a power delivery network to deliver power to the plurality of hardware circuitry components; a plurality of switches coupled to the power delivery network to control whether power is delivered to respective portions of the plurality of hardware circuitry components; a control network for the power delivery network, where the control network is coupled to the plurality of switches; and controller to send a signal on the control network to cause power delivery to be disabled to a particular portion of the plurality of hardware circuitry components; and a software controller executable by a processor to send switch engagement data to the controller, where the signal is based on the switch engagement data.

Example 33 includes the subject matter of example 32, further including: a second integrated circuit device including: a power delivery network to deliver power to the hardware circuitry components of the second device; and a plurality of switches coupled to the power delivery network of the second device to control whether power is delivered to respective components in the plurality of hardware circuitry components of the second device; and where the software controller is to send switch engagement data to control the plurality of switches of the first integrated circuit device and the plurality of switches of the second integrated in association with power management specific to a particular workload to be performed using both the first integrated circuit device and the second integrated circuit device.

Example 34 includes the subject matter of any one of examples 32-33, where control of the plurality of switches provides gate-level power-gating control to the software controller.

Example 35 includes the subject matter of any one of examples 32-34, where the software controller is further executable to: identify an application to be executed on the first integrated circuit device; determine that a subset of the plurality of hardware circuitry components are unused during execution of the application; and generate the switch engagement data based a determination that the subset of the plurality of hardware circuitry components are unused during execution of the application, where the particular portion of the hardware circuitry components includes the subset of the plurality of hardware circuitry components.

Example 36 includes the subject matter of any one of examples 32-35, where the first integrated circuit device is to generate report data to identify power use of respective hardware circuitry components in the plurality of hardware circuitry components, and the switch engagement data is based on the report data.

Example 37 includes the subject matter of any one of examples 32-36, where the plurality of switches are mapped to respective hardware circuitry components in the plurality of hardware circuitry components.

Example 38 includes the subject matter of example 37, where a particular one of the plurality of switches is mapped to and controls power delivery to a single standard cell in the plurality of hardware circuitry components.

Example 39 includes the subject matter of any one of examples 32-38, where a particular one of the plurality of switches is mapped to and controls power delivery to a single logic gate in the plurality of hardware circuitry components.

Example 40 includes the subject matter of any one of examples 32-39, where the integrated circuit device includes an intellectual property (IP) block, and the particular portion includes a subset of hardware of the IP block.

Example 41 includes the subject matter of any one of examples 32-40, where the integrated circuit device includes a system on chip.

Example 42 includes the subject matter of any one of examples 32-41, where the controller circuitry is to receive switch engagement data from software and generates the signal based on the switch engagement data.

Example 43 includes the subject matter of example 42, where the switch engagement data identifies, for each of the plurality of switches, whether the switch is to be open or closed.

Example 44 includes the subject matter of any one of examples 32-43, where the power delivery network is integrated in silicon of the integrated circuit device.

Example 45 includes the subject matter of any one of examples 32-44, where the controller circuitry is further to generate report data to indicate use of individual hardware circuitry components in the plurality of hardware circuitry components during a performance of a workload.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
an integrated circuit (IC) device comprising:
a plurality of hardware circuitry components;
a power delivery network to deliver power to the plurality of hardware circuitry components;
a plurality of switches coupled to the power delivery network to control whether power is delivered to respective portions of the plurality of hardware circuitry components;
a control network for the power delivery network, wherein the control network is coupled to the plurality of switches; and
controller circuitry to send a signal on the control network to cause power delivery to be disabled to a particular portion of the plurality of hardware circuitry components.

2. The apparatus of claim 1, wherein the plurality of switches are mapped to respective hardware circuitry components in the plurality of hardware circuitry components.

3. The apparatus of claim 2, wherein a particular one of the plurality of switches is mapped to and controls power delivery to a single standard cell in the plurality of hardware circuitry components.

4. The apparatus of claim 2, wherein a particular one of the plurality of switches is mapped to and controls power delivery to a single logic gate in the plurality of hardware circuitry components.

5. The apparatus of claim 1, wherein the integrated circuit device comprises an intellectual property (IP) block, and the particular portion comprises a subset of hardware of the IP block.

6. The apparatus of claim 1, wherein the integrated circuit device comprises a system on chip.

7. The apparatus of claim 1, wherein the controller circuitry is to receive switch engagement data from software and generates the signal based on the switch engagement data.

8. The apparatus of claim 7, wherein the switch engagement data identifies, for each of the plurality of switches, whether the switch is to be open or closed.

9. The apparatus of claim 1, wherein the power delivery network is integrated in silicon of the integrated circuit device.

10. The apparatus of claim 1, wherein the controller circuitry is further to generate report data to indicate use of individual hardware circuitry components in the plurality of hardware circuitry components during a performance of a workload.

11. At least one non-transitory machine-readable storage medium with instructions stored thereon, the instructions executable to cause a machine to:
identify an integrated circuit device to perform a workload, wherein the integrated circuit device comprises a power delivery network to deliver power to a plurality of hardware circuitry components, the power delivery network comprises a plurality of switches integrated in the power delivery network to control whether power is delivered to respective hardware circuitry components in the plurality of hardware circuitry components;
send a signal to the integrated circuit device based on the workload to cause a subset of the plurality of switches to be triggered to disable power delivery to a corresponding subset of the plurality of hardware circuitry components; and
trigger execution of at least a portion of the workload on the integrated circuit device while power delivery is disabled to the subset of the plurality of hardware circuitry components.

12. The storage medium of claim 11, wherein the subset of the plurality of hardware circuitry components comprises at least one of an individual standard cell of the integrated circuit device or an individual logic gate of the integrated circuit device.

13. The storage medium of claim 11, wherein the instructions are further executable to cause the machine to determine that the subset of the plurality of hardware circuitry components will be unused in the execution of at least the portion of the workload, wherein the signal is generated based on the determination that the subset of the plurality of hardware circuitry components will be unused.

14. The storage medium of claim 13, wherein the instructions are further executable to cause the machine to receive report data from the integrated circuit device, wherein the subset of the plurality of hardware circuitry components are determined to be unused in the execution of at least the portion of the workload based on the report data.

15. The storage medium of claim 11, wherein the instructions are further executable to cause the machine to:
identify policy data associated with the workload;
determine a power savings policy to be applied to the workload, wherein the signal is sent based at least in part on the power savings policy.

16. A system comprising:
a first integrated circuit device:
a plurality of hardware circuitry components;
a power delivery network to deliver power to the plurality of hardware circuitry components;
a plurality of switches coupled to the power delivery network to control whether power is delivered to respective portions of the plurality of hardware circuitry components;
a control network for the power delivery network, wherein the control network is coupled to the plurality of switches; and
controller to send a signal on the control network to cause power delivery to be disabled to a particular portion of the plurality of hardware circuitry components; and
a software controller executable by a processor to send switch engagement data to the controller, wherein the signal is based on the switch engagement data.

17. The system of claim 16, further comprising:
a second integrated circuit device comprising:
a power delivery network to deliver power to the hardware circuitry components of the second device; and
a plurality of switches coupled to the power delivery network of the second device to control whether power is delivered to respective components in the plurality of hardware circuitry components of the second device; and
wherein the software controller is to send switch engagement data to control the plurality of switches of the first integrated circuit device and the plurality of switches of the second integrated in association with power management specific to a particular workload to be performed using both the first integrated circuit device and the second integrated circuit device.

18. The system of claim 16, wherein control of the plurality of switches provides gate-level power-gating control to the software controller.

19. The system of claim 16, wherein the software controller is further executable to:
identify an application to be executed on the first integrated circuit device;
determine that a subset of the plurality of hardware circuitry components are unused during execution of the application; and
generate the switch engagement data based a determination that the subset of the plurality of hardware circuitry components are unused during execution of the application, wherein the particular portion of the hardware circuitry components comprises the subset of the plurality of hardware circuitry components.

20. The system of claim 16, wherein the first integrated circuit device is to generate report data to identify power use of respective hardware circuitry components in the plurality of hardware circuitry components, and the switch engagement data is based on the report data.
